(19) United States
(12) Patent Application Publication
(10) Pub. No.: US 2009/0093606 A1
(43) Pub. Date: Apr. 9, 2009

(54) Shape memory fibers prepared via wet, reaction, dry, melt, and electro spinning

(75) Inventors: Jinlian Hu, Kowloon (CN); Qinghao Meng, Kowloon (CN); Yong Zhu, Kowloon (CN); Jing Lu, Kowloon (CN); Haitao Zhuo, Kowloon (CN)

Correspondence Address: The Hong Kong Polytechnic University;Suite 600, Mailbox #119, 1800 Diagonal Road, Alexandria, VA, 22314, US

(73) Assignee: The Hong Kong Polytechnic University, Kowloon (HK)

(21) Appl. No.: 11/907,012

(22) Filed: Oct. 9, 2007

(51) Int. Cl. C08G 18/00

(52) U.S. Cl. 528/52; 528/48

(57) ABSTRACT

The present invention relates to methods for synthesizing shape memory polyurethanes, and fibers therefrom. The polyurethanes can be synthesized via solution polymerization or bulk polymerization. Following synthesis, the polyurethanes can be treated via wet spinning, dry spinning, reaction spinning, melt spinning, or electro spinning.

### BACKGROUND

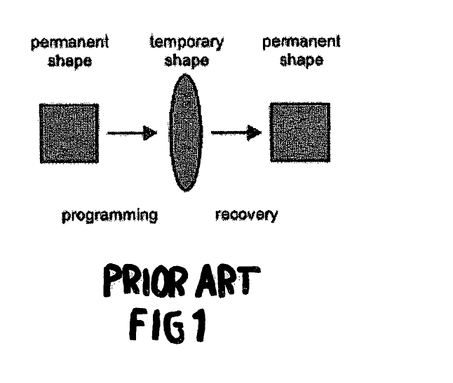

Shape memory polymers, after being strained, can restore their original shape upon heating above a certain temperature (i.e., switching transition temperature). FIG. 1 shows a schematic demonstration of the shape memory effect. By the programming process, the permanent shape is transferred to the temporary shape. Heating up of the polymer to a temperature above the switching temperature initiates the recovery of the permanent shape.

Though there have been many research papers on shape recovery polymers, the study on shape memory fibers is at its initial stage. Compared with shape memory polymer bulk, shape memory polymer fibers have outstanding mechanical properties because of their molecular orientation.

Several polymer systems have been reported possessing shape memory properties such as trans-polyisoprene (TPI), poly(styrene-co-butadiene), polynor bornene, shape memory polyurethane, etc. The most representative one is shape memory polyurethane because of its easy control of critical temperature. The molecular mechanism of the shape memory effect of the block copolymers is the formation of phase segregated morphology (hard segment phase and soft segment phase). They fall into three groups by the different switching transition temperature, the first is the soft segment melting transition temperature, and the second is a mixed glass transition temperature.

### DESCRIPTION

The present invention relates to methods for synthesizing shape memory polyurethane. The shape memory polyurethanes can be synthesized via solution polymerization or bulk polymerization. Following synthesis, the polyurethane can be further treated to provide shape memory fibers suitable for use in smart textiles and apparels, biomedical materials, high performance sensors, actuators, filtration media, etc. Further treatment to the polyurethane can include wet spinning, dry spinning, reaction spinning, melt spinning, and electro spinning.

These and other features, aspects, and advantages of the apparatus and methods of the present invention will become better understood from the following description, appended claims, and accompanying drawings where:

FIG. 1 shows a schematic demonstration of the shape memory effect;

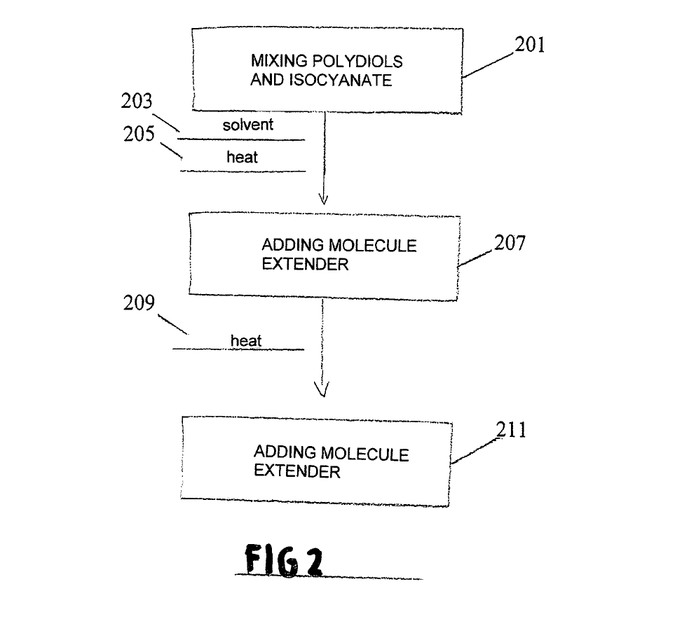

FIG. 2 shows an embodiment for making shape memory polyurethanes by bulk polymerization;

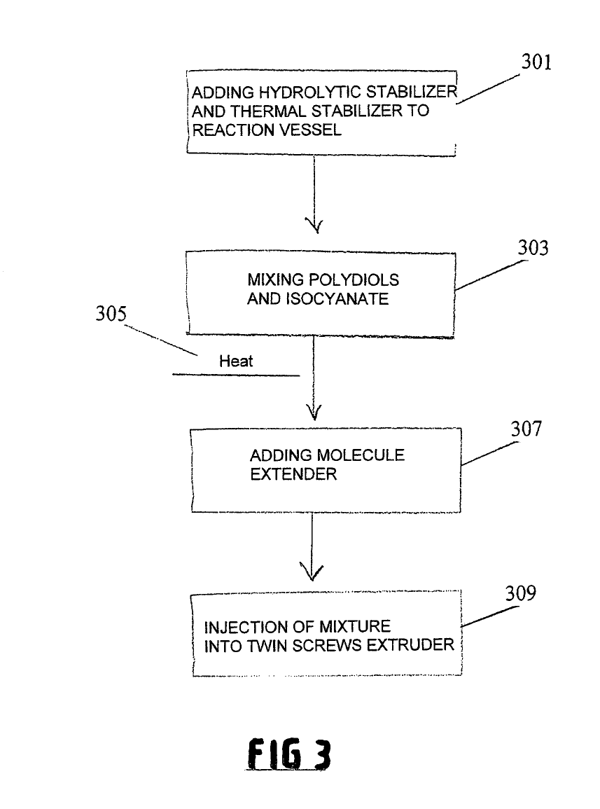

FIG. 3 is a further embodiment for making the present shape memory polyurethanes by bulk polymerization;

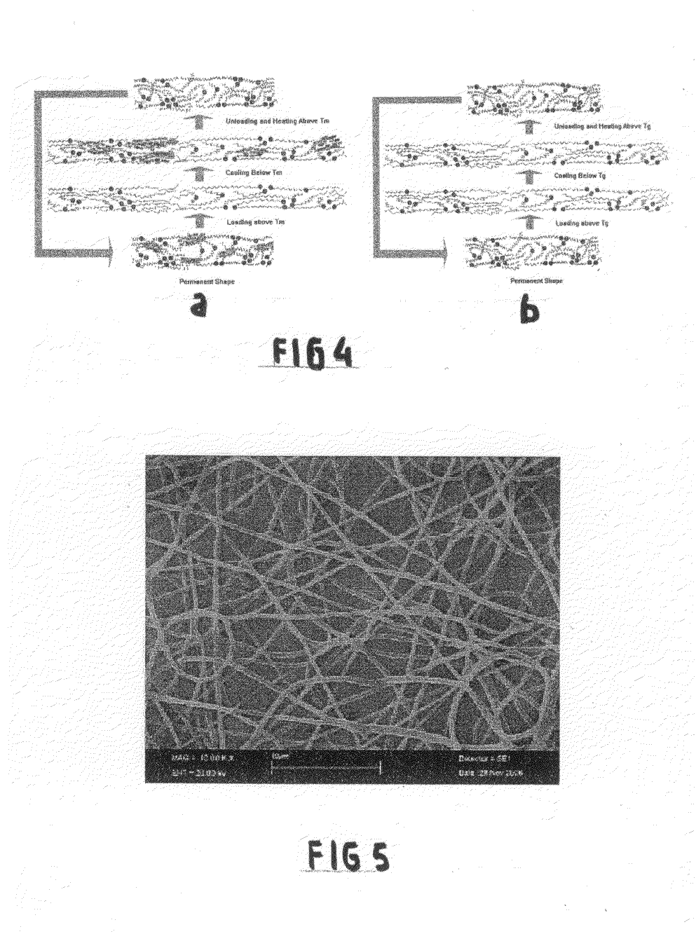

FIG. 4 exhibits the shape memory effect mechanism of the present shape memory polyurethane fibers; and

FIG. 5 shows the SEM image of the prepared nanofiber.

The following description of certain exemplary embodiment(s) is merely exemplary in nature and is in no way intended to limit the invention, its application, or uses. Throughout this description, the term “solution polymerization” shall refer to a process for producing shape memory polyurethane in solvent. “Bulk polymerization” shall refer to the conversion of monomer into a polymer without the acid of solvent. “Difunctional” shall refer to a compound having 2 reactive sites in each molecule.

Now, to FIGS. 2-5,

FIG. 2 is one embodiment for making shape memory polyurethanes of the present invention. FIG. 2 exhibits synthesis by solution polymerization. Firstly, a polydiol is mixed with an isocyanate 201 in the presence of a solvent 203 to form a mixture. The polydiol can be selected from the group consisting of poly(di(ethylene glycol)adipate), poly(ethylene adipate), poly(ε-caprolactone), poly(ethylene adipate), poly(tetrahydrofuran), poly(butylenes adipate), poly(propylene oxide), and mixtures thereof. The polydiol has a molecular weight ranging from 500 to 30000 mg. The isocyanate can be selected from the group consisting of isophorone diisocyanate, 4,4′-dicyclohexylmethane diisocyanate, 1,6-hexamethylene diisocyanate, alicyclic diisocyanates, diphenylemethane-4,4′-diisocyanate, tolulene diisocyanate, and tetramethylxylene diisocyanate. The molar ratio between the isocyanate and the summation hydroxyl ranges from 1:1 to 1:5. The polydiol and the isocyanate are both preferably difuctional compounds.

Suitable solvents can be selected from the group consisting of N,N-dimethylformamide (DMF), Dimethylformamide, N,N-Dimethylacetamide, 1-methyl-2-pyrrolidinane, and methyl sulfoxide.

The mixture is then heated 205 between 60° C. to about 90° C. for a period of between about 1 to about 4 hours. A molecule extender is then added to the mixture 207.

Suitable molecule extender can be selected from the group consisting of 1,3-propanediol, 1,4-butanediol, 1,2-ethanediol, 4,4′-dihydroxy biphenyl, 2,2-Bis(hydroxymethyl)propionic acid, N-Bis(2-hydroxyethyl)-isonicotinamide, N-methyldiethanolamine, Bisphenol A ethoxylate, 1,2-Diaminoethane, 1,2-Diaminopropane, and mixtures thereof. Heat is then applied to the mixture, between about 60° C. to about 90° C., for a period between 1 to about 4 hours 209. In one embodiment, during heating, solvent is continually added to the mixture.

FIG. 3 is another embodiment of a method making shape memory polyurethanes of the present invention. A polydiol and a isocyanate, as previously discussed, are mixed 303 to form a mixture. Heat is applied to the mixture 305 at between 70° C. to about 80° C. and allowed to react from 0.5 to about 1 hour. A molecule extender, as previously discussed, is added to the reaction vessel, with the temperature kept below 60° C. After several minutes, the mixture is injected into a twin screw extruder 309. Shape memory polyurethane chips are then produced.

The resultant shape memory polymer in the above methods is then further treated to produce shape memory fibers. Further treatments include wet spinning, dry spinning, melt spinning, reaction spinning, and electro spinning.

In one embodiment, following solution polymerization the polymers are further treated by wet spinning. During wet spinning, the solution solid concentration is adjusted to 20 to about 35 wt % and a viscosity of 50 to about 150 Pa·S using an appropriate solvent, such as N,N-dimethylformamide(DMF), Dimethylformamide, N,N-Dimethylacetamide, 1-Methyl-2-pyrrolidinone, or Methyl sulfoxide. This solution is extruded through orifices horizontally in a coagulation water bath to diffuse out the solvent with a given spinning speed. After passing the water bath, the filaments are taken up to apply subsequent processes including water bath for further removal of residual solvent and drying with hot air of 40 to about 80° C. Then, the filaments are wound up at a given velocity between 20 to about 100 m/min. In order to release the internal stress caused by the velocity difference among rollers in drying and winding process, the original shape memory fibers were treated with heating aftertreatment including stretching on hot rollers at 80 to about 150° C., or steaming at 100° C. at 400 kPa.

In another embodiment, following solution polymerization, the polymers are further treated by dry spinning. During dry spinning, the spinning solution solid concentration is adjusted to 25 to about 30 wt %. It is put through a spinneret by a spinning pump from the head pipe. After that, it is passed through a spinning tube which is about 5 to about 9 m long. Simultaneously, hot air is supplied to evaporate the solvent. The tube was heated to up to between 280 to about 340° C. in the upper and between 140 to about 180° C. in the lower. The solvent is recovered. The spinning speed is from 200 to about 1000 m/min. If diamines are used as extenders urea-urethane groups are formed and high mechanical properties fibers with good heat stability are obtained.

In another embodiment, following bulk polymerization, the polymers are further treated by melt spinning. During melt spinning, shape memory chips are dried at 60 to about 90° C. and 0.08 MPa for 6 h so that the chips moisture content reaches below 100 ppm. The shape memory fibers are spun in highly pure nitrogen environment using a 20 mm single screw extruder. The temperatures at the first zone, second zone, third zone, forth zone, extruder head, spinning pack, melt pipe and pump are 175 to about 190° C., 200 to about 215° C., 203 to about 218° C., 205 to about 220° C., 207 to about 222° C., 207 to about 222° C., 207 to about 222° C., 207 to about 222° C., respectively. Laminar air temperature can be 22° C. Winding speed is 100 to about 800 m/min. Overfeed speed is about 5 to about 40 m/min correspondingly.

In another embodiment, the polymers are further treated by reaction spinning. During reaction spinning, since the reaction of NCO with polyether or polyester diol or molecule extender only take several second with catalyzer, the shape memory polyurethane polymerization and the spinning process are combined. It is especially effective for the shape memory fiber with slight cross-linking to obtain higher mechanical properties by a triol or triamine because a relatively strong skin from the cross linked polyurea urethane is formed by immediate NCO-amine reaction. The shape memory fiber reaction spinning is as follows: (1) with highly pure nitrogen gas protection, mix a difunctional polyester or polyether diols (molecular weight from 500 to 30000) with excessive difunctional isocyanate to form a mixture at 70 to about 90° C. and to react for 1 to about 2 hour; (2) the pre-polymer including a muti-ol is extruded into a spin baths of diamines with portions of tramines to form shape memory fibers; (3) the fibers are further hardened in hot water or diamine/alcohol solutions. The spinning speed is from 100-500 m/min. The alcohol can be Trimethyolpropane, Dlycerin, 1,2,6-Hexanetriol, Trimethylolethane, Pentaerythritol, Pentane-1,2,3,4,5-pentol, Mannitol, or Sucrose. The diamine can be N,N-Bis(2-hydroxyethyl)-isonicotinamide, N-methyldiethanolamine, 1,2-Diaminoethane, 1,2-Diaminopropane or their mixtures. The triamine can be Diethylene triamine.

For electro spinning, shape memory polyurethanes can be prepared both by solution polymerization and bulk polymerization. For shape memory polyurethane prepared by solution polymerization, its solid concentration is diluted to 3 to about 12 wt % using a suitable solvent. The solvent is selected from such as N,N-dimethylformamide(DMF), Dimethylformamide, N,N-Dimethylacetamide, 1-Methyl-2-pyrrolidinone, or Methyl sulfoxide. For shape memory polyurethane prepared by bulk polymerization, the spinning melt is obtained by heating the polymer between 180 to about 230° C. During spinning, a controlled external electric field in the range of 12 KV to about 25 KV is imposed on the polyurethane solution or melt. The distance between the grounded aluminum sheet collector and the needle tip is 15 cm. The spinning solution flow speed is in the range of 0.04 ml/min to about 0.1 mm/min.

To get high dimension stability, the fibers are steamed in a vessel or treated in an oven at an elevated temperature in the relaxed state to remove internal stress. Generally, the fibers are steamed in a vessel for 10 minutes or treated in an oven at 130° C. for 10 minutes at the relaxed state.

FIG. 4 exhibits the shape memory mechanism of the prepared shape memory polyurethane fibers; (a) relates to Tm type shape memory effect and (b) relates to Tg type shape memory effect. The soft segments of polyester or polyether are shown as being coiled or folded on themselves. The schematic section length of the zig-gag line corresponds to one repeating unit within the polyol. The diisocyanates are shown as rigid circles. During spinning, in a highly polar solvent (wet spinning, dry spinning, reaction spinning and electro spinning), or at a temperature above the hard segment phase transition temperature (melt spinning, electro spinning), the fiber is spun. Upon solvent extraction into the water bath or cooling to a temperature below the switching, transition temperature the fibers are winded up and the permanent fiber shape is cast. In the unstretched state, the fibers have their molecules slightly oriented below the switching temperature (soft segment melting transition temperature, glass transition temperature or a mixed glass transition temperature). The hard segments are still but have a tendency to adhere each other through strong hydrogen bonding. If they are stretched at a temperature above transition temperature (Tₜᵣₐₙₛ) or below Tₜᵣₐₙₛ (cool draw), the soft segments are extended. When the temperature is cooled below Tₜᵣₐₙₛ, the soft segments are fixed. As a result, the internal stress is stored in the fiber and associated deformation is fixed temporally. If they are reheated to above Tₜᵣₐₙₛ, the soft segments become flexible. They resume to the folded configuration because of the internal stress stored between hard segments. As a result, the fiber recovers its original length.

The shape memory fibers prepared via the spinning methods have a tensile strength of more than 0.9 cN/dtex and elongation break at 350 to about 500%. The shape fixity ratio is more than 80% and shape recovery ratio higher than 85% measured using an Instron 4466 equipped with a thermal chamber. The switching transition temperature (Tₜᵣₐₙₛ₎ required for specific applications can be tuned from below zero to 100° C. by slight variation of the chemical compositions. The fiber initial modulus is also adjustable from 0.08 to about 0.3 cN/dtex by variation of the chemical compositions or spinning technology. The shape memory fibers prepared by electro spinning have a controllable diameter between 50 to about 700 nm by regulating the voltage, solid concentration, spinning speed, and melt viscosity.

The prepared shape memory fibers are suitable for user in a number of industries, for example, textiles. At a temperature below the switching transition temperature when creases usually develop, the original wrinkle-free textile can be restored once it is re-heated above the switching transition temperature. The un-deformed textiles shape can be reserved when it is cooled down to a temperature below the switching transition temperature. More important, the prepared textile has a controllable shape relying on the external stress and the shape can be fixed completely according to the external conditions.

### EXAMPLES

### 1 Wet Spinning

The shape memory polyurethane was synthesized using poly(butanediol-adipate) as the soft segment, and diphenylemethane-4,4′-diisocyanate and 1,4-butanediol as the -hard segment by solution polymerization. The filament was precipitated in the coagulation bath. The spinning conditions are listed in Table 1. The fiber was steamed for 10 minutes at the relaxed state to remove the internal stress. The prepared shape memory fiber properties are tabulated in Table 2

TABLE 1
The spinning conditions of the shape memory fiber
wet spinning

| Spinning conditions | Value |
|---|---|
| Solution temperature (° C.) | 25 |
| Spinneret orifice Diameter (mm) | 0.08 |
| Number of spinneret orifice | 36 |
| Water bath Temperature (° C.) | 25 |
| Drawing ratio in the raising | 1.5 |
| Drawing ratio of drier roller | 1.5 |
| Drier temperature (° C.) | 65 |
| Spinning velocity (m/min) | 20 |

TABLE 2
The properties of shape memory fiber prepared by
wet spinning

| Properties | Value |
|---|---|
| Linear density/dtex | 70 |
| Recovery rate/% | 91% |
| Fixity rate/% | 81% |
| Breaking Tenacity/cN/dtex | 1.2 |
| Initial modulus/cN/dtex | 0.27 |
| Breaking Elongation/% | 110 |
| Shrinkage in boiling water % | 6.24 |
| Switching transition Temp/° C. | 37.32 |

### 2 Dry Spinning

The shape memory polyurethane was synthesized using poly(butanediol-adipate) as the soft segment, and diphenylemethane-4,4′-diisocyanate and 1,4-butanediol as the hard segment by solution polymerization. The filament was precipitated in the hot air in a heated tube. The spinning conditions are tabulated in Table 3. The fiber was treated in an oven at 130° C. for 10 minutes at the relaxed state to remove the internal stress. The prepared shape memory fiber properties are tabulated in Table 4.

TABLE 3
The spinning conditions of the shape memory fiber
dry spinning

| Spinning conditions | Value |
|---|---|
| Solution temperature (° C.) | 25 |
| Spinneret orifice Diameter (mm) | 0.1 |
| Number of spinneret orifice | 16 |
| Tube first zone temperature (° C.) | 320 |
| Tube second zone temperature (° C.) | 220 |
| Tube third zone Temperature (° C.) | 150 |
| Spinning velocity (m/min) | 200 |

TABLE 4
The properties of shape memory polyurethane fiber
prepared by dry spinning

| Properties | Value |
|---|---|
| Linear density/dtex | 70 |
| Recovery rate/% | 92% |
| Fixity rate/% | 83% |
| Breaking Tenacity/cN/dtex | 1.2 |
| Initial modulus/cN/dtex | 0.22 |
| Breaking Elongation/% | 450 |
| Shrinkage in boiling water % | 5.24 |
| Switching transition Temp/° C. | 39.22 |

### 3 Reaction Spinning

The pre-polymer was prepared using poly(butanediol-adipate) as the soft segment while glycerin and diisocyanate as the hard segments. The spinning bath was ethylene diamine with diethylene triamine. The final hardening media was diamine solution. The spinning speed was 100 m/min. The spinning conditions are listed in Table 5. And the prepared shape memory fiber properties are tabulated in Table 6.

TABLE 5
The spinning conditions of the shape memory fiber
reaction spinning

| Spinning conditions | Value |
|---|---|
| Pre-polymer temperature (° C.) | 70 |
| Spinneret orifice Diameter (mm) | 0.1 |
| Number of spinneret orifice | 12 |
| Diamine bath Temperature (° C.) | 60 |
| Spinning velocity (m/min) | 50 |

TABLE 6
Properties of shape memory polyurethane fiber
prepared by reaction spinning

| Properties | Value |
|---|---|
| Linear density/dtex | 70 |
| Recovery rate/% | 90% |
| Fixity rate/% | 84% |
| Breaking Tenacity/cN/dtex | 1.3 |
| Initial modulus/cN/dtex | 0.25 |
| Breaking Elongation/% | 200 |
| Shrinkage in boiling water % | 3.00 |
| Switching transition Temp/° C. | 41.77 |

### 4 Melt Spinning

The shape memory polymer was prepared using poly(ε-caprolactone) diol (PCL) as the soft segment, and diphenylemethane-4,4′-diisocyanate and 1,4-butanediol as the hard segments, by bulk polymerization. The spinning conditions are listed in Table 7. And the prepared shape memory fiber properties are tabulated in Table 8.

TABLE 7
The spinning conditions of the shape memory fiber
melt spinning

| Spinning conditions | Value |
|---|---|
| First zone temperature/° C. | 180 |
| Second zone temperature/° C. | 205 |
| Third zone temperature/° C. | 208 |
| Forth zone temperature/° C. | 210 |
| Extruder head temperature/° C. | 212 |
| Spinning pack temperature/° C. | 212 |
| Melt pipe temperature/° C. | 212 |
| Pump temperature/° C. | 212 |
| Spinneret orifice Diameter | 0.3 |
| Number of spinneret orifice | 24 |
| Laminar air temperature/° C. | 22 |
| Extruder head pressure/MPa | 5.0 |
| Spinning velocity (m/min) | 400 |

TABLE 8
Properties of shape memory polyurethane fiber
prepared by melt spinning

| Properties | Value |
|---|---|
| Linear density/dtex | 40 |
| Recovery rate/% | 94% |
| Fixity rate/% | 84% |
| Breaking Tenacity/cN/dtex | 1.18 |
| Initial modulus/cN/dtex | 0.12 |
| Breaking Elongation/% | 490 |
| Shrinkage in boiling water % | 8.12 |
| Switching transition Temp/° C. | 42.07 |

### 5 Electro Spinning

PCL-4000 based shape memory polyurethane with 25 wt % hard segment content was synthesized by bulk polymerization technology. The obtained polyurethane number average molecular weight was 18,000 measured by a high performance liquid. The polyurethane was dissolved in DMF to prepare spinning solution. The spinning conditions are listed in Table 9. FIG. 5 shows the SEM image of the prepared nanofiber.

TABLE 7
The spinning conditions of the shape memory fiber
electro spinning

| Spinning conditions | Value |
|---|---|
| Solid concentration/wt % | 10 |
| Positive voltage applied/V | 20 |
| Distance between syringe and | 15 |
| collector/cm | |

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method of making shape memory polyurethanes, comprising the steps of
mixing a polydiol selected from the group consisting of poly(di(ethylene glycol)adipate), poly(ethylene adipate), poly(ε-caprolactone), poly(ethylene adipate), poly(tetrahydrofuran), poly(butylenes adipate), poly(propylene oxide), and mixtures thereof, with a isocyanate selected form the group consisting of isophorone diisocyanate, 4,4′-dicyclohexylmethane diisocyanate, 1,6-hexzmethylene diisocyanate, alicyclic diisocyanates, diphenylemethane-4,4′-diisoyanate, tolulene diisocyanate, and tetramethylxylene diisocyanate, and mixtures of; and
adding a molecule extender selected from the group consisting of 1,3-propanediol, 1,4-butanediol, 1,2-ethanediol, 4,4′-dihydroxy biphenyl, 2,2-Bis(hydroxymethyl)propionic acid, N-Bis(2-hydroxyethyl)-isonicotinamide, N-methyldiethamelamine, bisphenol A ethoxylate, 1,2-diaminoethane, 1,2-diaminopropane, and mixtures thereof; wherein said polydiol and said isocyanate are present in a ratio of 1:1 to 1:1.5.

2. The method of claim 1, wherein mixing said poydiols and said isocyanate occurs in the presence of a solvent selected from the group consisting of N,N-dimethylformamide, dimethylformamide, N,N-dimethylacetamide, 1-methyl-2-pyrrolidinane, and methyl sulfoxide.

3. The method of claim 1, further comprising the step of heating the polydiol/isocynate mixture between 60° C. to about 90° C. for between 1 to about 4 hours.

4. The method of claim 1, further comprising applying heat following the addition of the molecule extender between 60° C. to about 90° C. for between 1 to about 4 hours.

5. The method of claim 6, further comprising injecting the mixture into two in screws extender following adding the molecule extender.

6. A method of making a shape memory fiber comprising the steps of:
mixing a polydiol selected from the group consisting of poly(di(ethylene glycol)adipate), poly(ethylene adipate), poly(ε-caprolactone), poly(ethylene adipate), poly(tetrahydrofuran), poly(butylenes adipate), poly(propylene oxide), and mixtures thereof, with a isocyanate selected form the group consisting of isophorone diisocyanate, 4,4′-dicyclohexylmethane diisocyanate, 1,6-hexzmethylene diisocyanate, alicyclic diisocyanates, diphenylemethane-4,4′-diisoyanate, tolulene diisocyanate, and tetramethylxylene diisocyanate, and mixtures of;
adding a molecule extender selected from the group consisting of 1,3-propanediol, 1,4-butanediol, 1,2-ethanediol, 4,4′-dihydroxy biphenyl, 2,2-Bis(hydroxymethyl)propionic acid, N-Bis(2-hydroxyethyl)-isonicotinamide, N-methyldiethamelamine, bisphenol A ethoxylate, 1,2-diaminoethane, 1,2-diaminopropane, and mixtures thereof; and
treating said mixture to wet spinning, dry spinning, reaction spinning, melt spinning, or electro spinning.
